(19) United States
(12) Patent Application Publication
(10) Pub. No.: US 2025/0050779 A1
(43) Pub. Date: Feb. 13, 2025

(54) METHOD

(71) Applicant: TOYOTA JIDOSHA KABUSHIKI KAISHA, Toyota-shi (JP)

(72) Inventors: Ryosuke KOBAYASHI, Nagakute-shi (JP); Koichi WATANABE, Tokyo-to (JP); Motofumi KAMIYA, Nagoya-shi (JP); Masaki NISHINO, Anjo-shi (JP); Jean-Sebastien BOIRE, Yokohama-shi (JP); Takuya NISHIOKA, Nagoya-shi (JP); Yohei NAKANISHI, Nagoya-shi (JP); Masaki MAKIHARA, Okazaki-shi (JP)

(73) Assignee: TOYOTA JIDOSHA KABUSHIKI KAISHA, Toyota-shi (JP)

(21) Appl. No.: 18/797,513

(22) Filed: Aug. 8, 2024

(30) Foreign Application Priority Data
Aug. 10, 2023 (JP) 2023-131624

(51) Int. Cl. B60L 53/66; B60L 53/53; B60L 53/62

(52) U.S. Cl. CPC B60L 53/66; B60L 53/53; B60L 53/62; B60L 2240/62; B60L 2250/16

(57) ABSTRACT

A terminal apparatus identifies, based on a current location of a user vehicle, or a desired power supply location being a power supply location desired by a user, one or more power supply vehicles or one or more providers that satisfy a predetermined condition regarding power supply to the user vehicle. The terminal apparatus acquires, for each of the one or more power supply vehicles or the one or more providers, information regarding an available amount of power supply and information regarding a possible time of power supply start or a scheduled time of power supply completion. The terminal apparatus displays, for the each of the one or more power supply vehicles or the one or more providers, the information regarding the available amount of power supply and the information regarding the possible time of power supply start or the scheduled time of power supply completion on the terminal apparatus.

### CROSS-REFERENCE TO RELATED APPLICATION

This application claims priority to Japanese Patent Application No. 2023-131624 filed on Aug. 10, 2023, the entire contents of which are incorporated herein by reference.

### TECHNICAL FIELD

The present disclosure relates to a method.

### BACKGROUND

Technology for supplying power by a power supply vehicle when, for example, an electric vehicle runs out of electricity is known. For example, Patent Literature (PTL) 1 discloses technology in which a vehicle that has run out of electricity transmits information including the current position of the vehicle to a server and each of multiple power supply vehicles transmits information including the position of each power supply vehicle to the server, whereby the server selects a power supply vehicle to supply power to the vehicle that has run out of electricity.

### CITATION LIST

### Patent Literature

PTL 1: JP 2019-086841 A

### SUMMARY

There is room for improvement with respect to technology for supplying power by power supply vehicles.

It would be helpful to improve technology for supplying power by power supply vehicles.

A method according to an embodiment of the present disclosure is a method performed by a terminal apparatus, the method including:
identifying, based on a current location of a user vehicle, or a desired power supply location being a power supply location desired by a user, one or more power supply vehicles or one or more providers that satisfy a predetermined condition regarding power supply to the user vehicle; acquiring, for each of the one or more power supply vehicles or the one or more providers, information regarding an available amount of power supply and information regarding a possible time of power supply start or a scheduled time of power supply completion; and displaying, for the each of the one or more power supply vehicles or the one or more providers, the information regarding the available amount of power supply and the information regarding the possible time of power supply start or the scheduled time of power supply completion on the terminal apparatus.

According to an embodiment of the present disclosure, technology for supplying power by power supply vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of an information processing apparatus; and

FIG. 4 is a flowchart illustrating operations of the terminal apparatus.

### DETAILED DESCRIPTION

Hereinafter, an embodiment of the present disclosure will be described.

### Outline of Embodiment

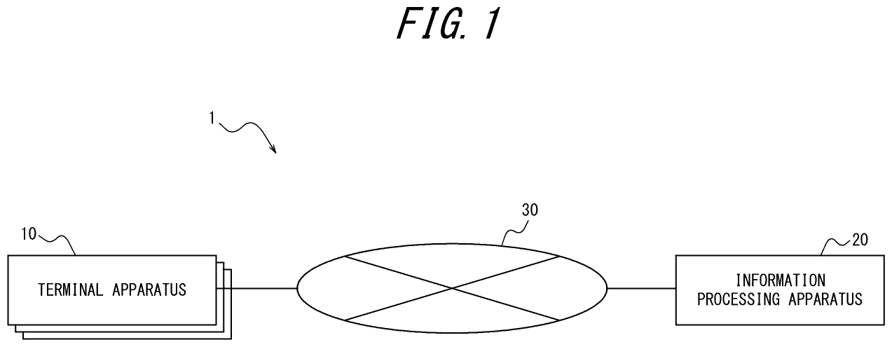

An outline of a system 1 according to an embodiment of the present disclosure will be described with reference to FIG. 1. The system 1 includes a plurality of terminal apparatuses 10 and an information processing apparatus 20. Each of the terminal apparatuses 10 and the information processing apparatus 20 are communicably connected to a network 30 including, for example, the Internet, a mobile communication network, or the like.

The terminal apparatuses 10 are computers, such as personal computers (PCs), smartphones, or tablet terminals, for example. In the present embodiment, the terminal apparatuses 10 are each used, for example, by a user who uses a service that dispatches the power supply vehicle to a location designated by the user and supplies power to the vehicle of the user at the location (hereinafter also referred to as “rush charging service”). The terminal apparatuses 10 may each be a computer mounted in a vehicle.

The information processing apparatus 20 is, for example, a computer such as a server apparatus. The information processing apparatus 20 can communicate with the plurality of terminal apparatuses 10 via the network 30. In the present embodiment, the information processing apparatus 20 may be a server of a provider that provides rush charging services.

First, an outline of the present embodiment will be described, and details thereof will be described later. Based on the current location of the user vehicle or the desired power supply location being the power supply location desired by the user, the terminal apparatus 10 identifies the power supply vehicle or provider that satisfies the predetermined condition regarding power supply to the user vehicle. The terminal apparatus 10 then acquires, for each power supply vehicle or provider, information regarding the available amount of power supply and information regarding the possible time of power supply start or scheduled time of power supply completion. The terminal apparatus 10 then displays, for each power supply vehicle or provider, information regarding the available amount of power supply and information regarding the possible time of power supply start or scheduled time of power supply completion on the terminal apparatus 10.

The user may not necessarily wish to fill the user vehicle to full capacity through the power supply service by the power supply vehicle; for example, the user may wish to charge the vehicle by a specific time, even with a small amount of charge. According to the present embodiment, by being able to check the available amount of power supply and the possible time of power supply start or scheduled time of power supply completion for each power supply vehicle or provider, the user can select a rush charging service in accordance with the user's preferences. Therefore, according to the present embodiment, the technology for supplying power by a power supply vehicle is improved in that the user can select the rush charging service in line with the user's preferences.

Next, configurations of the system 1 will be described in detail.

### (Configuration of Terminal Apparatus)

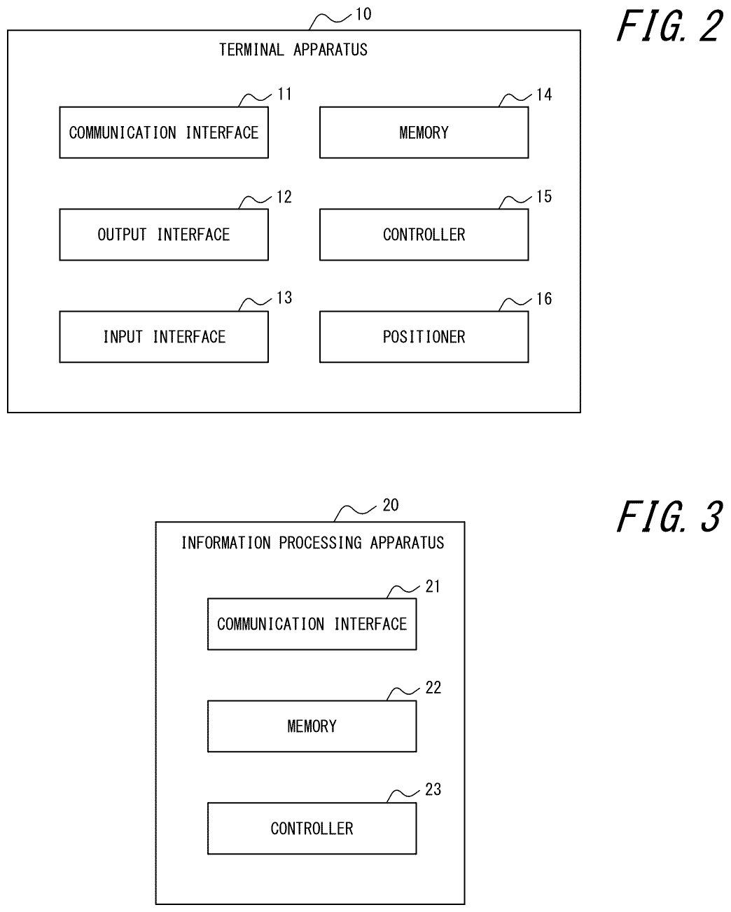

As illustrated in FIG. 2, the terminal apparatus 10 includes a communication interface 11, an output interface 12, an input interface 13, a memory 14, a controller 15, and a positioner 16.

The communication interface 11 includes at least one communication interface for connecting to the network 40. The interface for communication is compliant with mobile communication standards such as the 4th generation (4G) standard or the 5th generation (5G) standard, for example, but these examples are not limiting. In the present embodiment, the terminal apparatus 10 communicates with the information processing apparatus 20 via the communication interface 11 and the network 30.

The output interface 12 includes at least one output device for outputting information. The output device is a display for outputting information as video, a speaker for outputting information as audio, or the like, for example, but is not limited to these. Alternatively, the output interface 12 may include an interface for connecting to an external output device.

The input interface 13 includes at least one input device for detecting an input operation by the user. The input device is a physical key, a capacitive key, a mouse, a touch panel, a touch screen integrally provided with a display of the output interface 12, a microphone, or the like, for example, but is not limited to these. Alternatively, the input interface 13 may include an interface for connecting to an external input device.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information to be used for operations of the terminal apparatus 10. Optional information used in the operation of the terminal apparatus 10 includes the maximum power supply capacity, residual power supply amount, and state of charge (SOC) of the user vehicle pertaining to the terminal apparatus 10. For example, the memory 14 may also store a system program, an application program, embedded software, or the like. For example, the information stored in the memory 14 may be updated with, for example, information acquired from the network 40 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire terminal apparatus 10.

The positioner 16 includes at least one device for acquiring positional information for the terminal apparatus 10. Specifically, the positioner 16 includes, for example, a receiver compliant with GPS, but is not limited to this example and may include a receiver compliant with any appropriate satellite positioning system.

### (Configuration of Information Processing Apparatus)

As illustrated in FIG. 3, the information processing apparatus 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the plurality of terminal apparatuses 10 and the power supply vehicle via the communication interface 21 and the network 30. The information processing apparatus 20 may communicate with other information processing apparatus, such as the provider's information processing apparatus.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, embedded software, a database, and the like. The information stored in the memory 22 may be updated with, for example, information acquired from the network 30 via the communication interface 21.

The controller 23 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 23 controls the operations of the entire information processing apparatus 20.

### (Flow of Operations of System 1)

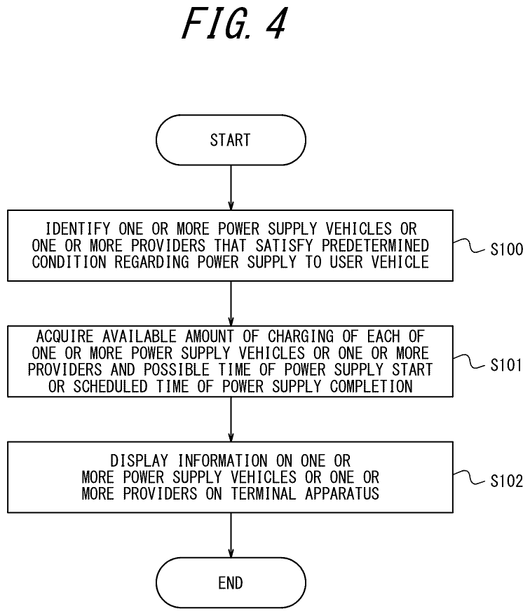

With reference to FIG. 4, operations of the terminal apparatus 10 in the system 1 according to the present embodiment will be described.

S100: The controller 15 of the terminal apparatus 10 identifies, based on the current location of the user vehicle, or the desired power supply location being the power supply location desired by the user, one or more power supply vehicles or one or more providers that satisfy the predetermined condition regarding power supply to the user vehicle.

Specifically, a user who wishes to use the rush charging service uses the terminal apparatus 10 to input information regarding his/her wish to use the charging service. The input of information regarding the desired use of the charging service may be made, for example, using an input form displayed on the screen of the terminal apparatus 10 or by opening a website for making a reservation for the use of the rush charging service with a browser, but any input method, including but not limited to the above, may be employed.

Triggered by the user's input of information regarding the user's desire to use the charging service, the controller 15 of the terminal apparatus 10 transmits, via the communication interface 11 and the network 30, information regarding the user's desire to use the service and information regarding the current location of the user's vehicle, or the desired power supply location being the power supply location desired by the user to the information processing apparatus 20. Next, the controller 23 of the information processing apparatus 20, which receives the information via the communication interface 21, identifies the power supply vehicle or provider that satisfies the predetermined condition regarding power supply to the user vehicle, and transmits the information on the power supply vehicle or provider that satisfies the predetermined condition to the terminal apparatus 10, thereby allowing the controller 15 to identify the power supply vehicle or the provider that satisfies the predetermined condition regarding power supply to the user vehicle.

The “predetermined condition” may be defined freely. For example, the predetermined condition may include that the power supply vehicle or provider is located within a predetermined distance, which may be arbitrarily determined, from the current location of the user vehicle or the power supply location desired by the user. In such a case, the controller 23 may identify the power supply vehicle by, for example, receiving the current location of the power supply vehicle or the destination point of the power supply vehicle from the power supply vehicle via the network 30 and determining whether it is within a predetermined distance from the current location of the user vehicle or the power supply location desired by the user, or may identify the provider by transmitting the current location of the user vehicle or the power supply location desired by the user to the information processing apparatus of the provider via the network 30 and receiving information from the information processing apparatus of the provider regarding whether or not the user vehicle can be supplied with power.

The “current location of the user vehicle” or the “current location of the power supply vehicle” can be obtained by any method, for example, by using GPS.

The “desired power supply location” can be acquired by any method, such as using the input form displayed on the screen of the terminal apparatus 10.

The “predetermined distance” can be any distance, including 100 m, 200 m, 500 m, 1 km, 2 km, 5 km, 10 km, etc. The predetermined distance may be changeable. The predetermined distance may be calculated using the SOC of the user vehicle, as described below.

Instead of the information processing apparatus 20 communicating with the power supply vehicle or provider, the terminal apparatus 10 may communicate directly with the power supply vehicle or provider via the communication interface 21. In such cases, the process performed by the controller 23 may be performed by the controller 15 instead.

S101: The controller 15 acquires information regarding the available amount of power supply and information regarding the possible time of power supply start or scheduled time of power supply completion for each of the power supply vehicles or the providers.

Specifically, when the controller 15 receives the information on the power supply vehicle or the information on the provider in S100, it acquires the information regarding the available amount of power supply and the information on the possible time of power supply start or scheduled time of power supply completion, respectively, included in the information on the power supply vehicle or the information on the provider.

The information on the power supply vehicle or the provider may include, but not be limited to, information on the fees charged for the use of the rush charging service, and may include any other information.

S102: The controller 15 displays on the terminal apparatus 10 information regarding the available amount of power supply for each of the power supply vehicles or providers, and information regarding the possible time of power supply start or scheduled time of power supply completion.

Specifically, the controller 15 displays the information regarding the available amount of power supply acquired in S101 and the information regarding the possible time of power supply start or scheduled time of power supply completion on the terminal apparatus 10 for each of the power supply vehicles or providers in any manner, such as by displaying them on the map displayed on the screen of the terminal apparatus 10 in association with each of the power supply vehicles or providers, or by displaying them in association with each of the power supply vehicles or providers displayed in a list on the screen.

The information regarding the available amount of power supply displayed on the screen of the terminal apparatus 10 may be displayed in SOC. In such a case, the controller 15 calculates SOC by dividing the total value, which is the sum of the residual charge amount of the user vehicle acquired from the memory 14 and the available amount of power supply acquired in S101, by the full charge capacity of the user vehicle acquired from the memory 14.

For example, the controller 15 may further display information on the terminal apparatus 10 about the fee charged for the use of the rush charging service for each power supply vehicle or provider.

For example, when displaying information regarding the available amount of power supply, the controller 15 may display information regarding the available amount of power supply of the power supply vehicle or the provider, among the power supply vehicles or the providers, for which the sum of the available amount of power supply of the power supply vehicle or the provider and the residual charge amount of the user vehicle is less than the full charge capacity of the user vehicle.

Specifically, the controller 15 calculates the total value, which is the sum of the residual charge amount of the user vehicle acquired from the memory 14 and the available amount of power supply acquired in S101, for each of the power supply vehicles or providers. Next, the controller 15 compares the total value calculated for each of the power supply vehicles or providers with the full charge capacity of the user vehicle acquired from the memory 14 for each of the power supply vehicles or providers. As a result of the comparison, in the case of the power supply vehicle or provider for which the total value is less than the full charge capacity of the user vehicle, the information regarding the available amount of power supply is displayed, and in the case of the power supply vehicle or provider for which the total value is equal to or more than the full charge capacity of the user vehicle, the information regarding the available amount of power supply is not displayed.

As described above, the terminal apparatus 10 identifies a power supply vehicle or provider that satisfies the predetermined condition regarding power supply to the user vehicle, based on the current location of the user vehicle, or the desired power supply location being the power supply location desired by the user. The terminal apparatus 10 then acquires, for each power supply vehicle or provider, information regarding the available amount of power supply and information regarding the possible time of power supply start or scheduled time of power supply completion. The terminal apparatus 10 then displays, for each power supply vehicle or provider, information regarding the available amount of power supply and information regarding the possible time of power supply start or scheduled time of power supply completion on the terminal apparatus 10.

According to this configuration, when a user wants to charge a small amount of battery by a specific time, for example, the user can check the available amount of power supply and the possible time of power supply start or scheduled time of power supply completion for each power supply vehicle or provider, so that the user can select a rush charging service that meets the user's needs. Therefore, according to the present embodiment, the technology for supplying power by a power supply vehicle is improved in that the user can select the rush charging service in line with the user's preferences.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the terminal apparatus 10 in the above embodiment are distributed to multiple computers capable of communicating with each other can be implemented. For example, an embodiment in which some or all of the components of the terminal apparatus 10 are provided in the information processing apparatus 20 can also be implemented. For example, the information processing apparatus 20 may be equipped with some or all of the components of the terminal apparatus 10.

For example, in the embodiment described above, the terminal apparatus 10 may filter the power supply vehicles or providers to be displayed by the available amount of power supply, or the possible time of power supply start or scheduled time of power supply completion.

Specifically, the controller 15 of the terminal apparatus 10 provides a filtering function on the screen on the terminal apparatus 10 to be displayed in S102, so that the user can filter the displayed power supply vehicles or providers by the available amount of power supply or the possible time of power supply start or scheduled time of power supply completion, as desired by the user. In addition to filtering, the controller 15 may also sort the displayed power supply vehicles or providers in ascending or descending order by the available amount of power supply, or the possible time of power supply start or scheduled time of power supply completion.

For example, in the embodiment described above, the terminal apparatus 10 may acquire a minimum SOC being a minimum SOC desired by the user, and a desired time of power supply start or a desired time of power supply completion desired by the user, set a recommendation degree for each of the power supply vehicles or the providers based on the minimum SOC and the available amount of power supply of each of the power supply vehicles or the providers, or the desired time of power supply start or the desired time of power supply completion and the possible time of power supply start or the scheduled time of power supply completion, and change the display mode of each of the power supply vehicles or the providers according to the recommendation degree.

Specifically, the controller 15 of the terminal apparatus 10 acquires the minimum SOC, or the desired time of power supply start or desired time of power supply completion by having the user input the minimum SOC, or the desired time of power supply start or desired time of power supply completion. The controller 15 then sets a recommendation degree for each of the power supply vehicles or providers based on the difference between the minimum SOC and the SOC calculated using the available amount of power supply as described above, or the difference between the desired time of power supply start and the possible time of power supply start of the power supply vehicle or provider, or the difference between the desired time of power supply completion and the scheduled time of power supply completion of the power supply vehicle or provider. The controller 15 then changes the display mode of each of the power supply vehicles or providers according to the recommendation degree for each of the power supply vehicles or providers.

For example, the controller 15 may set the recommendation degree higher as the difference between the minimum SOC and the SOC calculated using the available amount of power supply as described above increases, or may set the recommendation degree higher as the difference between the desired time of power supply start and the possible time of power supply start of each power supply vehicle or provider decreases, or as the difference between the desired time of power supply completion and the scheduled time of power supply completion of each power supply vehicle or provider decreases. For example, the controller 15 may set the recommendation degree set by the difference between the desired time of power supply start and the possible time of power supply start of each power supply vehicle or provider higher than the recommendation degree set by the difference between the minimum SOC and the SOC calculated using the available amount of power supply as described above, or vice versa. The method of setting the recommendation degree may be changeable.

For example, the controller 15 may base its recommendation degrees for each of the power supply vehicles or providers on any information, including but not limited to information about the fees charged for using the rush charging service.

The “recommendation degree” may be expressed, for example, by a number, with a higher number indicating a higher recommendation degree, or a lower number indicating a higher recommendation degree, but various other expressions of recommendation degree may be used, including but not limited to the following.

Various display modes may be used for the “display modes”, including, for example, but not limited to, colors such as red, blue, yellow, etc., shapes such as circles, double circles, etc., and numbers or symbols.

For example, in the embodiment described above, in a case in which a change in information on the power supply vehicles or the providers has occurred, the terminal apparatus 10 may display, based on the information after the change, information regarding the available amount of power supply of each of the power supply vehicles or the providers, and information regarding the possible time of power supply start or the scheduled time of power supply completion.

Specifically, the controller 15 of the terminal apparatus 10 repeatedly acquires information on the power supply vehicle or provider from the information processing apparatus 20 via the network 30 at predetermined time intervals. Next, the controller 15 compares the previous information of the power supply vehicle or provider with the retrieved information of the power supply vehicle or provider to see if any changes have occurred. If a change has occurred, information regarding the available amount of power supply of the power supply vehicle or provider and information regarding the possible time of power supply start or scheduled time of power supply completion is displayed based on the information after the change.

The “predetermined time interval” can be any time interval, including every second, every 2 seconds, every 5 seconds, every 10 seconds, every minute, every 2 minutes, every 10 minutes, every 30 minutes, and every hour. The predetermined time interval may be changed as needed.

The controller 15 may also acquire information on the power supply vehicle or provider from the information processing apparatus 20 in real time.

The information processing apparatus 20 may send the information on the power supply vehicle or provider to the terminal apparatus 10 only when a change in information on the power supply vehicle or provider has occurred in response to a request to acquire the information on the power supply vehicle or provider of the terminal apparatus 10.

The controller 15 may also communicate directly with the power supply vehicle or provider via the communication interface 21 to repeatedly acquire information on the power supply vehicle or provider at predetermined time intervals.

For example, an embodiment in which a general purpose computer functions as the terminal apparatus 10 according to the above embodiment can also be implemented. Specifically, a program in which processes for realizing the functions of the terminal apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by a terminal apparatus, the method comprising:
identifying, based on a current location of a user vehicle, or a desired power supply location being a power supply location desired by a user, one or more power supply vehicles or one or more providers that satisfy a predetermined condition regarding power supply to the user vehicle;
acquiring, for each of the one or more power supply vehicles or the one or more providers, information regarding an available amount of power supply and information regarding a possible time of power supply start or a scheduled time of power supply completion; and
displaying, for the each of the one or more power supply vehicles or the one or more providers, the information regarding the available amount of power supply and the information regarding the possible time of power supply start or the scheduled time of power supply completion on the terminal apparatus.

2. The method according to claim 1, wherein the terminal apparatus, when displaying the information regarding the available amount of power supply, displays information regarding an available amount of power supply of a power supply vehicle or a provider among the one or more power supply vehicles or the one or more providers, a sum of the available amount of power supply of the power supply vehicle or the provider and a residual charge amount of the user vehicle being less than a full charge capacity of the user vehicle.

3. The method according to claim 1, further comprising filtering the one or more power supply vehicles or the one or more providers to be displayed by the available amount of power supply, or the possible time of power supply start or the scheduled time of power supply completion.

4. The method according to claim 1, further comprising:
acquiring a minimum SOC being a minimum SOC desired by the user, or a desired time of power supply start or a desired time of power supply completion desired by the user;
setting a recommendation degree for the each of the one or more power supply vehicles or the one or more providers based on the minimum SOC and the available amount of power supply of the each of the one or more power supply vehicles or the one or more providers, or the desired time of power supply start or the desired time of power supply completion and the possible time of power supply start or the scheduled time of power supply completion; and
changing a display mode of the each of the one or more power supply vehicles or the one or more providers according to the recommendation degree.

5. The method according to claim 1, further comprising, in a case in which a change in information on the one or more power supply vehicles or the one or more providers has occurred, displaying, based on the information after the change, information regarding the available amount of power supply of the each of the one or more power supply vehicles or the one or more providers, and information regarding the possible time of power supply start or the scheduled time of power supply completion.
